(19) United States
(12) Patent Application Publication
(10) Pub. No.: US 2025/0077453 A1
(43) Pub. Date: Mar. 6, 2025

(54) HMB Random and Sequential Access Coherency Approach

(71) Applicant: Western Digital Technologies, Inc., San Jose, CA (US)

(72) Inventors: Amir SEGEV, Meiter (IL); Shay BENISTY, Beer Sheva (IL); Adi BLUM, Kibbutz Tzora (IL)

(73) Assignee: Western Digital Technologies, Inc., San Jose, CA (US)

(21) Appl. No.: 18/461,777

(22) Filed: Sep. 6, 2023

(51) Int. Cl. G06F 13/28

(52) U.S. Cl. CPC G06F 13/28; G06F 2213/28

(57) ABSTRACT

Read commands and write commands are issued by a data storage device, but sometimes a read command can begin execution prior to the data for the write command having been written to the memory device (or HMB DRAM). In such a scenario, the data for the read command is not in the memory device, but rather, is in cache waiting to be written to the memory device in a write cache operation. In order to ensure the correct data is read, the cache write operation can be paused so that the data can be retrieved from cache rather than the memory device. Alternatively, a placeholder can be used for the read command until the write cache operation has occurred.

### BACKGROUND OF THE DISCLOSURE

### Field of the Disclosure

Embodiments of the present disclosure generally relate to achieving a desired coherency in read/write operations.

### Description of the Related Art

Nonvolatile memory (NVM) express (NVMe) devices need to manage large logical to physical (L2P) tables. The bigger the storage, the bigger the L2P tables. The tables reside in the memory device (e.g., NAND) when the data storage device is not powered, but an active copy is stored in dynamic random access memory (DRAM) when available. Using the memory device to manage L2P tables will kill the data storage device performance. Hence the usage of DRAM to avoid killing data storage device performance.

DRAM, while having better performance than the memory device to L2P table management, is still too slow for higher performance. Therefore a caching mechanism is typically used. The caching mechanism allows for random access that occurs for L2P management necessitated by input/output (I/O) reads/writes. The caching hides the latency involved in accessing DRAM.

However, pure caching is not sufficient alone as during boot operations, or before turning off the power, the entire L2P table needs to move from the memory device to DRAM (during power up) and from DRAM to the memory device (during power down). Also during tables refresh, parts of the DRAM needs to be copied to/from NAND. Due to the moving between DRAM and the memory device, the random access is to slow, so in addition to cache accesses, direct memory access (DMA) is utilized.

The use of DMA as well as cache can create coherency issues. The central processing unit (CPU)/firmware (FW) thread that is responsible for I/O transfer might try to update the L2P table due to a write command, but a different thread/CPU might be dealing with power-loss notification and hence a write command may fail to execute prior to receiving a read command. The result is coherency problems in read/write operations.

Therefore, there is a need in the art for improved coherency in read/write operations.

### SUMMARY OF THE DISCLOSURE

Read commands and write commands are issued by a data storage device, but sometimes a read command can begin execution prior to the data for the write command having been written to the memory device (or HMB DRAM). In such a scenario, the data for the read command is not in the memory device, but rather, is in cache waiting to be written to the memory device in a write cache operation. In order to ensure the correct data is read, the cache write operation can be paused so that the data can be retrieved from cache rather than the memory device. Alternatively, a placeholder can be used for the read command until the write cache operation has occurred.

In one embodiment, a data storage device comprises: a memory device; and a controller coupled to the memory device, wherein the controller is configured to: initiate a read command to a direct memory access (DMA) module; pause writing to the memory device from a cache; retrieve data associated with the read command from cache; and return the retrieved data as read data of the read command.

In another embodiment, a data storage device comprises: a memory device; and a controller coupled to the memory device, wherein the controller is configured to: pause a cache operation of writing data to the memory device; substitute data from the memory device with data from the cache; and resume the cache operation after the substituting.

In another embodiment, a data storage device comprises: means for storing data; and a controller coupled to the means for storing data, wherein the controller is configured to: initiate a read command; determine that an address associated with the read command overlaps with an address in cache; prioritize a direct memory access (DMA) operation over a cache read operation; and execute the read command using data from the cache and not from the means for storing data.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of a DRAM controller according to one embodiment.

FIG. 3 is a flowchart illustrating coherency issues with read/write commands.

FIG. 4 is a schematic illustration of a DRAM controller interacting with HMB according to one embodiment.

FIG. 5 is a flowchart illustrating improvement in read/write coherency according to one embodiment.

FIG. 6 is a schematic illustration of a storage system according to one embodiment.

FIG. 7 is a flowchart illustrating read command processing according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Read commands and write commands are issued by a data storage device, but sometimes a read command can begin execution prior to the data for the write command having been written to the memory device (or HMB DRAM). In such a scenario, the data for the read command is not in the memory device, but rather, is in cache waiting to be written to the memory device in a write cache operation. In order to ensure the correct data is read, the cache write operation can be paused so that the data can be retrieved from cache rather than the memory device. Alternatively, a placeholder can be used for the read command until the write cache operation has occurred.

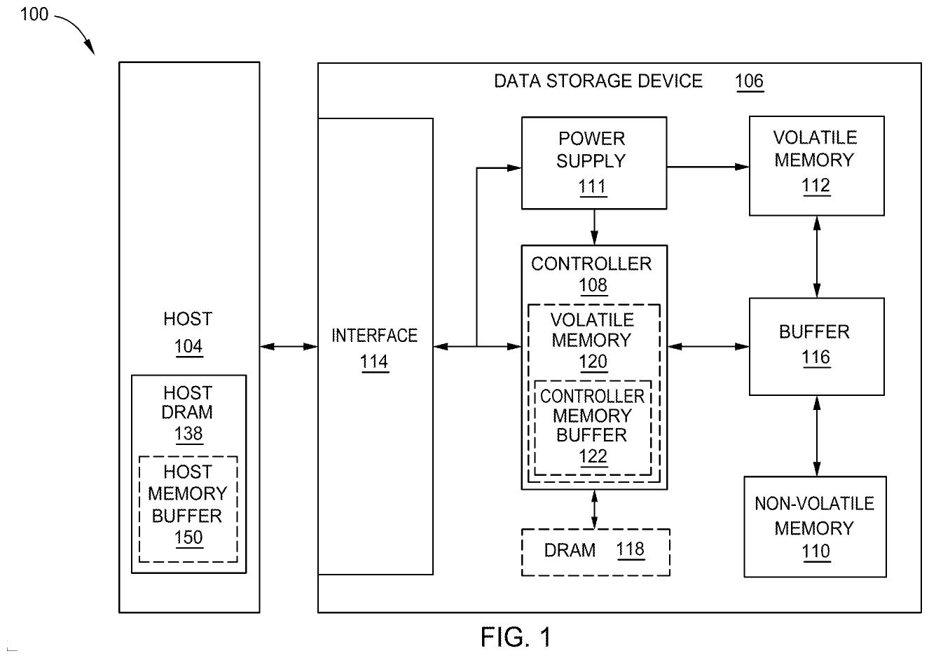

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

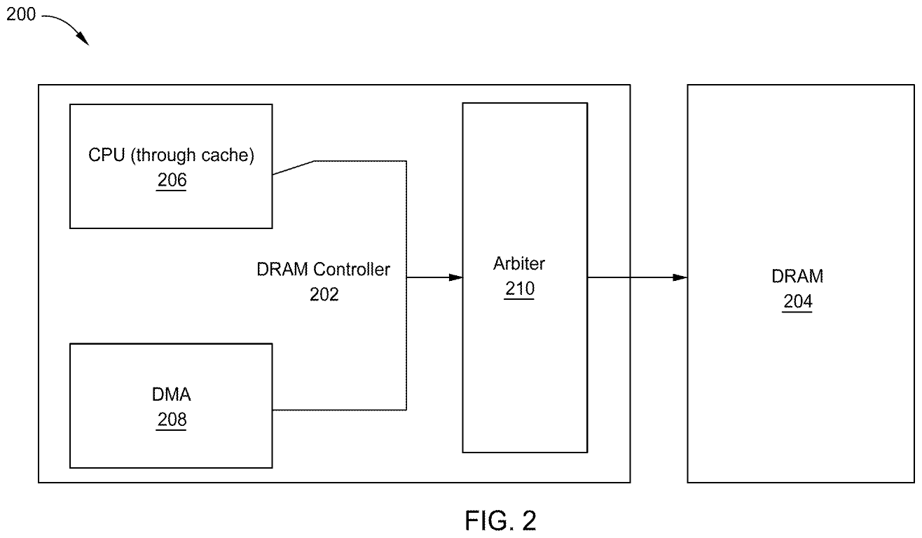

FIG. 2 is a schematic illustration of a DRAM controller according to one embodiment. FIG. 2 shows a system 200 having the DRAM controller 202 coupled to DRAM 204. The DRAM controller 202 includes a central processing unit (CPU) (i.e., through cache) 206 and direct memory access (DMA) 208 coupled to an arbiter 210 that is coupled to the DRAM 204. The CPU 206 uses random accesses while utilizing a cache algorithm. The DMA 208 handles large transfers where cache is only optional. The arbiter 210 selects between cache requests caused by ransom accesses of CPU and DMA requests.

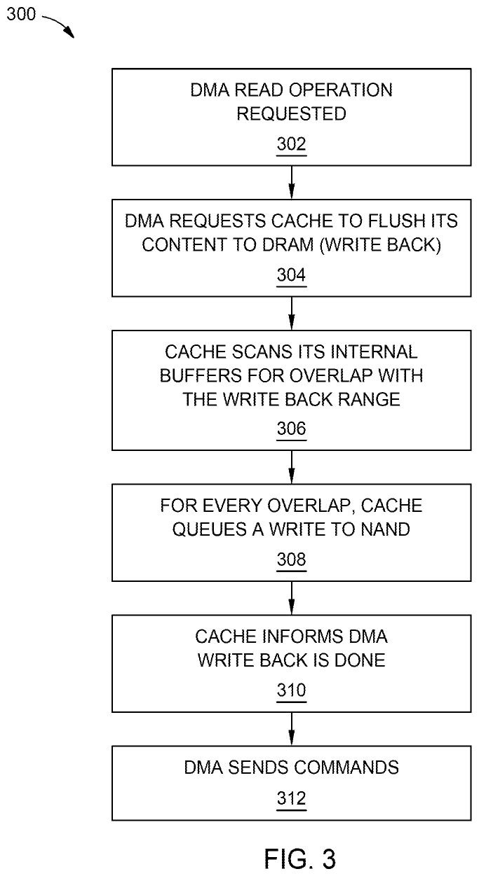

The use of two different engines, DMA and Cache/CPU, can cause coherency issues. The coherency issues arise because the CPU/FW-thread responsible for input/output (I/O) transfer might try to update the L2P table due to a write command, but a different thread/CPU might be dealing with power-loss notification, meaning there is a need to “DMA” the entire L2P table from DRAM back to the memory device (e.g., NAND). The DMA operation should collect a complete and correct status of the L2P tables. As such, a “write back” flow is introduced as shown in FIG. 3.

FIG. 3 is a flowchart 300 illustrating coherency issues with read/write commands. In the embodiment shown in FIG. 3, the write cache has priority over the DMA. Otherwise, read commands could be processed prior to the write back occurring, thus resulting in a return of bad data to the requestor. Therefore, when the DMA processes a read command, the DMA needs to make sure the data in DRAM is up to date. The way to make sure the data is up to date is the write back process discussed in FIG. 3 where everything in cache is written to DRAM.

As shown in FIG. 3, the process begins when a DMA read operation is requested at 302. The DMA requests the cache to flush the cache contents to DRAM in a write back operation at 304. The cache scans the internal buffers for overlap with the write back range at 306. For every overlap, the cache queues a write to the memory device (e.g., NAND) at 308. The cache informs the DMA that the write back is done at 310, and the DMA then sends the read commands at 312.

More specifically, when the DMA receives a read command, the DMA will start by requesting the cache to do a write back. The cache then scans the cache's ‘dirty’ addresses to find overlaps to the write back request done by the DMA. For every match found, the cache queues towards the arbiter the write back to be performed. The cache does not wait for the write back to be actually performed. When the cache responds to the DMA, the write-back is completed. The DMA than queues to the arbiter the DMA's read requests.

Working with a DRAM-less device, using HMB as a substitute to local DRAM, introduces some differences. The DRAM, being on the host side, is “FAR” from the DMA/Cache engines, so every read and writes takes time. Also, the PCIe interface is full duplex, so as to utilize the interface better, reads and writes should work in parallel.

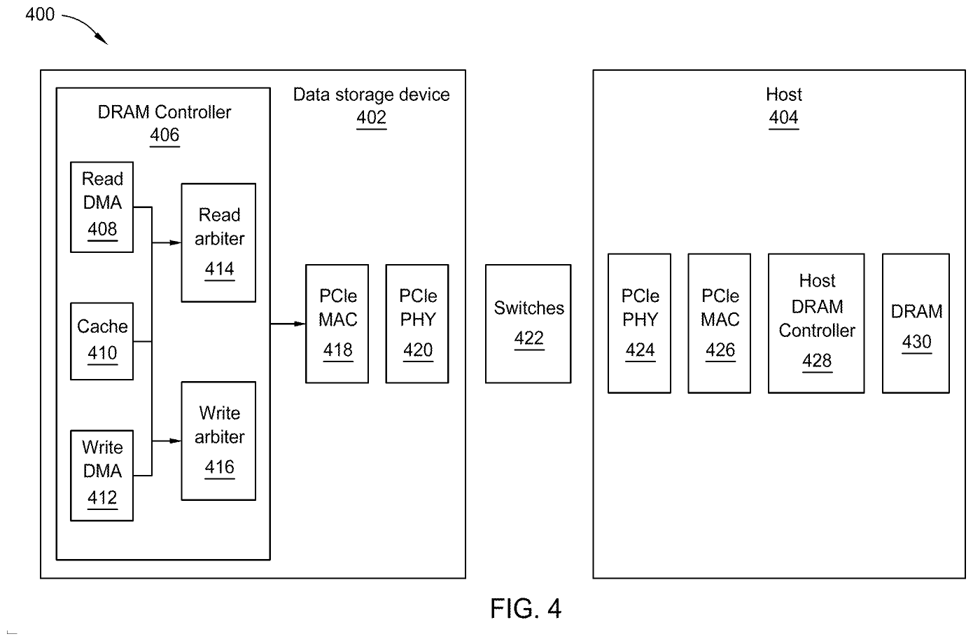

Sometimes, the DRAM is actually HMB where there is full bandwidth, but long latency. The read commands and write commands can be processed in parallel in such a system. As will be shown in FIG. 4, the PCIe will control at the point of the PCIe MAC 418 and write commands can bypass the read commands, but the read commands cannot bypass the write commands. The arbitration will need to be done separately while still maintaining coherency while the read commands and write commands are processed in parallel. It is to be noted that if the I/O slows down the write commands, the read commands could finish first with bad data.

FIG. 4 is a schematic illustration of a DRAM controller interacting with HMB according to one embodiment. The system 400 includes a data storage device 402 and a host 404. The data storage device 402 includes the DRAM controller 406 that has a read DMA 408, a cache 410, and a write DMA 412. Both the READ DMA 408 and the cache 410 are coupled to the read arbiter 414 while the cache 410 and write DMA are coupled to the write arbiter 416. The DRAM controller 406 is coupled to a PCIe MAC. The data storage device 402 also includes a PCIe PHY 420. The host 404 includes a PCIe PHY 424, PCIe MAC 426, host DRAM controller 428, and DRAM 430. The host 404 and data storage device 402 interact through switches 422.

The fact that the HMB-DRAM is ‘far’ makes use of the full duplex for performance valuable. However, the fact that the read arbiter 414 is separated from the write arbiter 416 means the coherency guaranteed by the arbiter, also preferring cache, does not hold. More specifically, the following scenario is likely to occur. The read DMA 408 requests the cache 410 to perform a write-back. The cache 410 queues cache writes to the write arbiter 416. The read DMA 408 queues DMA reads to the read arbiter 414. If the write is being back-pressured because of PCIe activities not related to the HMB, the read from the DMA might be serviced before the write-back, which, in turn, leads to bad (i.e., old) data being read.

The disclosure herein addresses the solution on how to achieve coherency while using “FAR”/HMB DRAM on a full duplex interface. The previous approach was to flush the overlapping dirty lines (i.e., overlapping with the DMA request) from the cache and quiesce the device interface before performing the DMA read. However, during power-loss, as example, this might be a lengthy solution. Also, on other incidents, quiescing the device has performance implications.

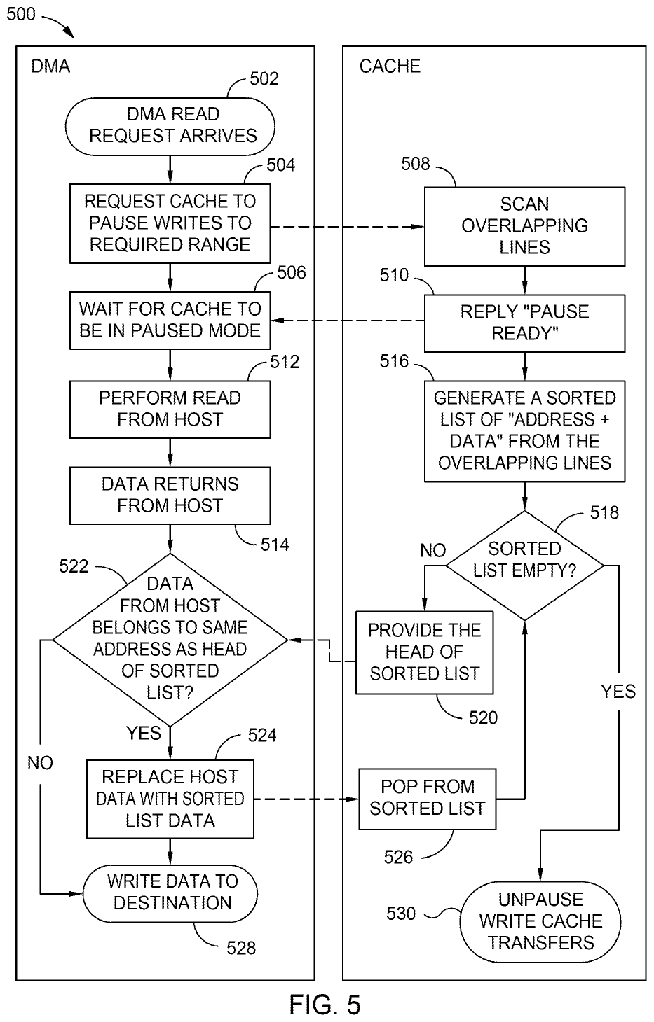

The approach discussed herein is to stall cache writes, perform the read, and replace overlapping lines with the value in the cache. FIG. 5 is a flowchart illustrating improvement in read/write coherency according to one embodiment. Looking at the DMA, the flow starts when the DMA gets a read request. The DMA will first request the cache to pause all writes to the DMA, and two parallel flows will begin. On the left is the DMA part. The DMA first asks the cache to pause all writes. Once the writes are paused, the DMA begins to fetch data from the host, which in this case is the host DRAM. As data is returned from the host, the DMA checks if the cache has data for the same range that the cache read. If the answer is yes, the data returned from the host is replaced with the data from the cache, and the DMA informs the cache that the overlapping data has been “used” so the cache can prepare the next data. If the arriving (from host) data does not have overlapping range in the cache, or after the DMA replaced the overlapping data, the data is written to the destination address.

On the right is the cache part. When the cache gets a “scan” request, the cache stops updating the writing of cached data, and when the cache pipes are clear, the cache informs the DMA. The cache then generates a list of all the overlaps the cache found, sorted by address. If the list is empty, the cache can continue to work. If the list is not empty, the information is provided to the DMA. The DMA will pop from that list as the DMA uses the cache provided data from the overlapping ranges. Once the list is emptied, the cache can continue to work normally.

It is important to note that the method discussed in FIG. 5, as opposed to previous approaches, prioritizes ‘reads’ in general over ‘writes’. Where previous versions prioritized cached over DMA. The reprioritization is a welcomed side-affect as responses to reads is something the device is waiting for. While writes tend to be posted so they do not delay anything else.

The solution illustrated in FIG. 5 results in not using a write back procedure. Rather, the data is taken directly from cache because the write commands can bypass the read commands. Broadly speaking, FIG. 5 illustrates processing of a read command by the DMA whereby the cache pauses writing data to the memory device, the DMA retrieves data from both the memory device and cache (which may be HMB) and compares the data address to a cache data address. If there is a match, cache data is the correct data. If there is no match, then the data from the memory device is fine.

As illustrated in FIG. 5, initially a DMA read request arrives at 502 in the DMA. The DMA then requests the cache to pause writes to the required range associated with the read request at 504. In so requesting the pause, the DMA informs the cache of the required range associated with the read request. Correspondingly, in response to the request to pause, the cache scans the overlapping lines to find anything in the required range associated with the read request at 508. The cache then replies with a “pause ready” notification to the DMA at 510. While waiting for the pause ready notification, the DMA simply waits for the cache to be in paused mode at 506.

Once the DMA receives the pause ready notification, the DMA performs a read from the host, or more specifically from the memory device at 512 and returns the data from the memory device at 514. While the DMA is performing the read operation, the cache generates a sorted list of “address+data” from the overlapping lines at 516 and determines whether the sorted list is empty at 518. As sometimes happens, the cache and DMA share the same range of data addresses. If the sorted list is empty at 518, then the cache unpauses the write cache transfers at 530 because there is no data associated with the read request in cache. However, if the sorted list is not empty at 518, then the cache provides the head of the sorted list to the DMA at 520.

The DMA determines whether the data returned from the memory device belongs to the same address as the head of the sorted list provided by the cache at 522. If the data from the memory device does not belong to the same address as the head of the sorted list, then the DMA simply writes the data to the destination at 528. However, if the data from the memory device does belong to the same address as the head of the sorted list, then the DMA replaces the memory device retrieved data with the sorted list data at 524 and informs the cache which then pops the data that replaced the memory device data from the sorted list at 526 and then rechecks whether the sorted list is empty at 518.

In another embodiment, when the DMA is about to perform a read from an address that overlaps, the DMA can skip that read, as the DMA knows in advance that there is pending data to replace it in the cache. To do that, the DMA needs to add a “place holder” in the response due to first in first out (FIFO) procedures, so that the data is properly ordered coming out of the device.

As an example, if the DMA is about to perform a read for four different addresses: Address #1, Address #2, Address #3, and Address #4, but Address #3 is in cache, the DMA can retrieve data for Address #1 and Address #2 per normal operations. Then, for Address #3, because the data for Address #3 is in cache, a placeholder is placed for Address #3. Thereafter, for Address #4, the data is retrieved per normal operations. Once the data for Address #3 is written to the memory device, the data for Address #3 is retrieved and replaces the placeholder at which point the data for Address #3 and Address #4 can be delivered to the source of the read command. In so doing, FIFO is maintained. In another embodiment, the controller may pause all reads associated with data in cache and wait for the data to be written from cache to DRAM.

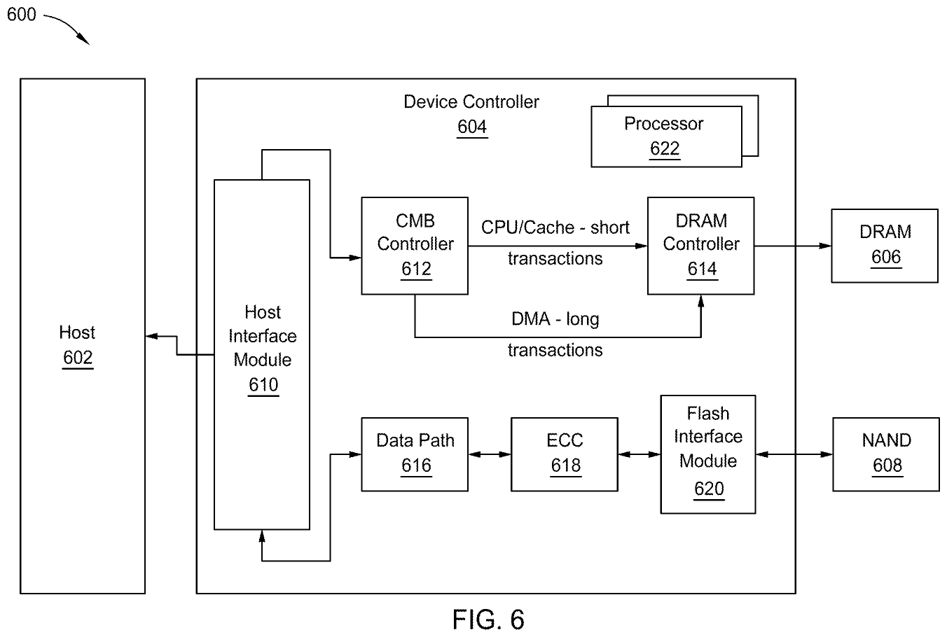

In yet another embodiment that uses both the DRAM CPU/cache and DMA methods is the Controller Memory Buffer (CMB). In this use case, short accesses to CMB may use the CPU/cache method (e.g., FIG. 5) while long accesses to CMB may use the DMA method (e.g., FIG. 3). The same algorithm shown in FIG. 5 and discussed herein can be used for both HMB and CMB. Short accesses to CMB might be submission queue, completion queue, PRP and SGL accesses while long accesses might be user data. FIG. 6 summarizes the embodiment.

FIG. 6 is a schematic illustration of a storage system 600 according to one embodiment. The system 600 includes a host device 602, device controller 604, DRAM 606, and NAND (i.e., memory device) 608. The device controller 604 includes a host interface module (HIM) 610, CMB controller 612, DRAM controller 614, data path 616, error correction code (ECC) module 618, flash interface module (FIM) 620, and one or more processors 622. The HIM 610 is coupled to the CMB controller 612 and data path 616. The data path 616 is coupled to the ECC module 618 which is coupled to the FIM 620 which is coupled to the NAND 608. Data flows in both directions from the HIM 610, through the data path 616, ECC module 618, FIM 620, and NAND 608. Data also flows from the CMB controller 612 to the DRAM controller 614 and then the DRAM 606.

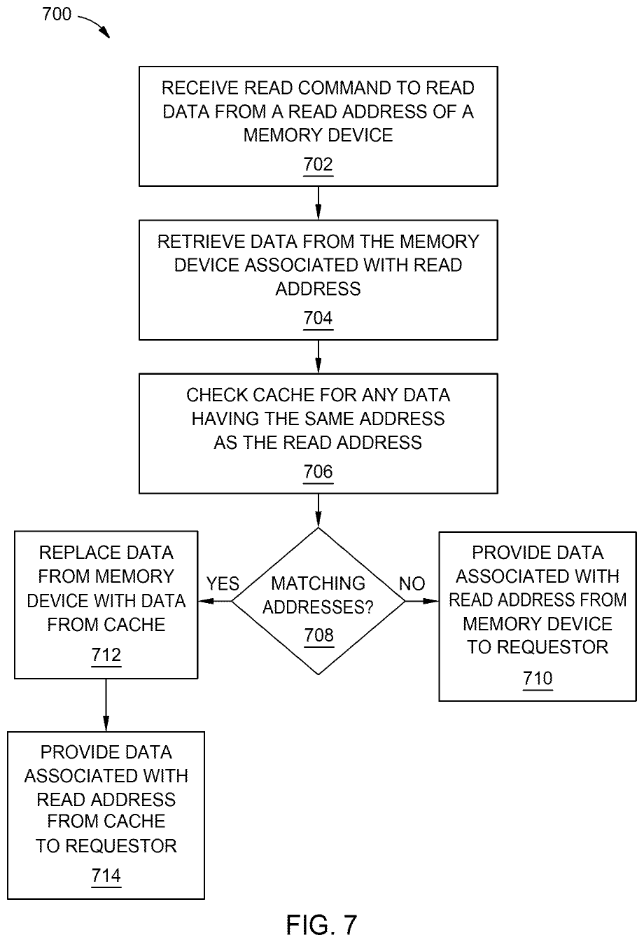

FIG. 7 is flowchart 700 illustrating read command processing according to one embodiment. Initially, a read command is received at 702. The read command is to read data from a certain read address of a memory device. The data is retrieved from the memory device at 704, but before delivering the data to the requestor, the cache is checked to see if the address, and corresponding data associated with the address, is in cache at 706.

Data that is in cache is identified by the address where the data will be written to the memory device. The data sits in cache while waiting to be written to the memory device. Once the data is written to the memory device, the data is no longer in cache. When reading data, data associated with the address of the read command may be in two distinct locations, the memory device itself or cache. If there is data in cache associated with the address of the read command, the data in cache is the most up to date data while the data in the memory device associated with the address of the read command is old or bad data. The proper execution of the read command results in returning valid (i.e., most up to date) data to the requestor.

If there is no address in cache that matches the address for the read command at 708, then the data retrieved from the memory device is provided to the read command requestor because the data from the memory device is the most up to date data. If, however, there is an address in cache that matches the read address, then the data retrieved from the memory device is replaced with data from the cache at 712 and then provided to the requestor at 714 because the data from the cache is the most up to date data.

By pausing a cache operation, prioritizing a DMA read over a cache write, and substituting host provided data with cache dirty data, the data storage device achieves a coherency between CPU random (cache) access and DMA accesses over a far and full duplex DRAM. The coherency goals for DRAM/cache nature of DRAM are met on a DRAM-less device, which saves bandwidth when trying to read from a dirty range, and provides priority to reads over write operations. Thus, there is improved coherency in read/write operations.

In one embodiment, a data storage device comprises: a memory device; and a controller coupled to the memory device, wherein the controller is configured to: initiate a read command to a direct memory access (DMA) module; pause writing to the memory device from a cache; retrieve data associated with the read command from cache; and return the retrieved data as read data of the read command. The cache is a host memory buffer (HMB). The data storage device does not include dynamic random access memory (DRAM). The controller is configured to read data from the memory device and substitute the read data with the retrieved data. The DMA is configured to request the cache to pause writing. The controller is configured to: scan overlapping lines in the cache in response to the request; reply to the DMA that the pause has occurred; and generate a sorted list of address and data from the overlapping lines. The controller is configured to determine whether the sorted list is empty. In response to determining that the sorted list is not empty, provide a head of the sorted list to the DMA. The DMA is configured to: perform a read from the memory device; and determine whether data associated with the read from the memory device belongs to a same address as the head of the sorted list. The DMA is configured to: replace the data associated with the read from the memory device with the data from the sorted list; and return the data from the sorted list to a destination that instructed the read command. The controller is configured to pop the data from the sorted list from the sorted list.

In another embodiment, a data storage device comprises: a memory device; and a controller coupled to the memory device, wherein the controller is configured to: pause a cache operation of writing data to the memory device; prioritize direct memory access (DMA) over the cache operation; substitute data from the memory device with data from the cache; and resume the cache operation after the substituting. Short accesses utilize cache. Input/output (I/O) operations utilize DMA. Short accesses include physical region page (PRP), scatter gather list (SGL), submission queues (SQ), and completion queues (CQ). The short accesses are through a controller memory buffer (CMB) controller. The controller is configured to: generate a sorted list of address plus data from overlapping lines in cache; provide the sorted list to DMA; determine that data associated with a read command is in the sorted list; and perform the substituting based upon the determining.

In another embodiment, a data storage device comprises: means for storing data; and a controller coupled to the means for storing data, wherein the controller is configured to: receive a read command; determine that an address associated with the read command overlaps with an address in cache; prioritize a direct memory access (DMA) operation over a cache read operation; and execute the read command using data from the cache and not from the means for storing data. The controller is configured to: read data for a first address associated with the read command from the means for storing data; skip reading data for a second address associated with the read command from the means for storing data; and read data for a third address associated with the read command from the means for storing data. The controller is configured to: return the data associated with the first address; insert a placeholder for data associated with the second address; return data associated with the third address; retrieve data associated with the second address; replace the placeholder with the data associated with the second address; deliver the data associated with the first address; deliver the data associated with the second address; and deliver the data associated with the third address after delivering the data associated with the second address.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
initiate a read command to a direct memory access (DMA) module;
pause writing to the memory device from a cache;
retrieve data associated with the read command from cache; and
return the retrieved data as read data of the read command.

2. The data storage device of claim 1, wherein the cache is a host memory buffer (HMB).

3. The data storage device of claim 1, wherein the data storage device does not include dynamic random access memory (DRAM).

4. The data storage device of claim 1, wherein the controller is configured to read data from the memory device and substitute the read data with the retrieved data.

5. The data storage device of claim 1, wherein the DMA is configured to request the cache to pause writing.

6. The data storage device of claim 5, wherein the controller is configured to:
scan overlapping lines in the cache in response to the request;
reply to the DMA that the pause has occurred; and
generate a sorted list of address and data from the overlapping lines.

7. The data storage device of claim 6, wherein the controller is configured to determine whether the sorted list is empty.

8. The data storage device of claim 7, wherein in response to determining that the sorted list is not empty, provide a head of the sorted list to the DMA.

9. The data storage device of claim 8, wherein the DMA is configured to:
perform a read from the memory device; and
determine whether data associated with the read from the memory device belongs to a same address as the head of the sorted list.

10. The data storage device of claim 9, wherein the DMA is configured to:
replace the data associated with the read from the memory device with the data from the sorted list; and
return the data from the sorted list to a destination that instructed the read command.

11. The data storage device of claim 10, wherein the controller is configured to pop the data from the sorted list from the sorted list.

12. A data storage device, comprising:
a memory device; and
a controller coupled to the memory device, wherein the controller is configured to:
pause a cache operation of writing data to the memory device;
substitute data from the memory device with data from the cache; and
resume the cache operation after the substituting.

13. The data storage device of claim 12, wherein short accesses utilize cache.

14. The data storage device of claim 13, wherein input/output (I/O) operations utilize DMA.

15. The data storage device of claim 14, wherein short accesses include physical region page (PRP), scatter gather list (SGL), submission queues (SQ), and completion queues (CQ).

16. The data storage device of claim 15, wherein the short accesses are through a controller memory buffer (CMB) controller.

17. The data storage device of claim 12, wherein the controller is configured to:
generate a sorted list of address plus data from overlapping lines in cache;
provide the sorted list to DMA;
determine that data associated with a read command is in the sorted list; and
perform the substituting based upon the determining.

18. A data storage device, comprising:
means for storing data; and
a controller coupled to the means for storing data, wherein the controller is configured to:
initiate a read command;
determine that an address associated with the read command overlaps with an address in cache;
prioritize a direct memory access (DMA) operation over a cache read operation; and
execute the read command using data from the cache and not from the means for storing data.

19. The data storage device of claim 18, wherein the controller is configured to:
read data for a first address associated with the read command from the means for storing data;
skip reading data for a second address associated with the read command from the means for storing data; and
read data for a third address associated with the read command from the means for storing data.

20. The data storage device of claim 19, wherein the controller is configured to:
return the data associated with the first address;
insert a placeholder for data associated with the second address;
return data associated with the third address;
retrieve data associated with the second address;
replace the placeholder with the data associated with the second address;
deliver the data associated with the first address;
deliver the data associated with the second address; and
deliver the data associated with the third address after delivering the data associated with the second address.
